(19) United States
(12) Patent Application Publication
(10) Pub. No.: US 2022/0309691 A1
(43) Pub. Date: Sep. 29, 2022

(54) COMPUTER-READABLE RECORDING MEDIUM STORING COUNTING PROGRAM, METHOD OF COUNTING, AND INFORMATION PROCESSING APPARATUS

(71) Applicant: FUJITSU LIMITED, Kawasaki-shi (JP)

(72) Inventors: Shinji Shigeno, Oita (JP); Kozo Baba, Oita (JP)

(73) Assignee: FUJITSU LIMITED, Kawasaki-shi (JP)

(21) Appl. No.: 17/589,526

(22) Filed: Jan. 31, 2022

(30) Foreign Application Priority Data
Mar. 23, 2021 (JP) 2021-048913

(51) Int. Cl. G06T 7/50; G06V 10/22; G06V 10/20; G06V 10/75; G06T 7/62; G06V 10/764

(52) U.S. Cl. CPC G06T 7/50; G06V 10/225; G06V 10/255; G06V 10/751; G06T 7/62; G06V 10/764; G06T 2207/30242

(57) ABSTRACT

A non-transitory computer-readable recording medium stores a counting program for causing a computer to execute a process including: obtaining a captured image that includes a plurality of objects; identifying a shape of an object included in a specific region of the captured image; and counting a number of the plurality of objects included in the captured image based on the identified shape.

### CROSS-REFERENCE TO RELATED APPLICATION

This application is based upon and claims the benefit of priority of the prior Japanese Patent Application No. 2021-48913, filed on Mar. 23, 2021, the entire contents of which are incorporated herein by reference.

### FIELD

The embodiments discussed herein are related to a computer-readable recording medium storing a counting program, a method of counting, and an information processing apparatus.

### BACKGROUND

In some cases, work to count the number of items is performed. For example, in some cases, the number of items is counted so as to check whether the number of the items to be shipped matches the ordered number of the items, or the number of items is checked during inspection. However, manual counting causes counting errors and takes time. Accordingly, techniques for assisting the counting of items have been considered.

Japanese Laid-open Patent Publication Nos. 2011-39872 and 2019-57211 are disclosed as related art.

### SUMMARY

According to an aspect of the embodiments, a non-transitory computer-readable recording medium stores a counting program for causing a computer to execute a process including: obtaining a captured image that includes a plurality of objects; identifying a shape of an object included in a specific region of the captured image; and counting a number of the plurality of objects included in the captured image based on the identified shape.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing apparatus according to a first embodiment;

FIG. 2 is a diagram illustrating an example of hardware of an information processing apparatus according to a second embodiment;

FIG. 3 is a diagram illustrating an example of functions of the information processing apparatus;

FIG. 4 is a diagram illustrating an example of processing of the information processing apparatus;

FIG. 5 is a diagram illustrating an example of calculation of the area;

FIGS. 6A to 6D are diagrams illustrating examples of minimum circumcircles;

FIG. 7 is a flowchart illustrating an example of the processing of the information processing apparatus; and

FIGS. 8A and 8B are diagrams illustrating examples of a display of the counting result of the information processing apparatus.

### DESCRIPTION OF EMBODIMENTS

For example, there has been proposed an article counting apparatus that generates template data of articles to be counted from an image of only one of the articles captured by imaging means. Thereafter, the proposed article counting apparatus obtains a counting object image in which a plurality of articles to be counted are present and counts the number of articles included in the counting object image by using the template data.

There has also been proposed a part counting apparatus that obtains a histogram of the number of pixels of the connected components of part color portions in an image obtained by capturing a sheet over which the parts are arranged and detects overlap of the parts in each of the connected components based on the histogram. The proposed part counting apparatus counts the number of parts in accordance with the connected components of the part color portions in the image when the overlap of the parts is not detected in the connected components of all the part color portions in the image.

As described above, it is conceivable that an apparatus counts the objects included in an image by using the template data that has been registered in advance in the apparatus. However, with this method, an object for which the template data has not been registered in advance in the apparatus is not necessarily counted.

In one aspect, an object of the present disclosure is to provide a counting program, a method of counting, and an information processing apparatus with which an object that has not been registered in advance may be counted.

### First Embodiment

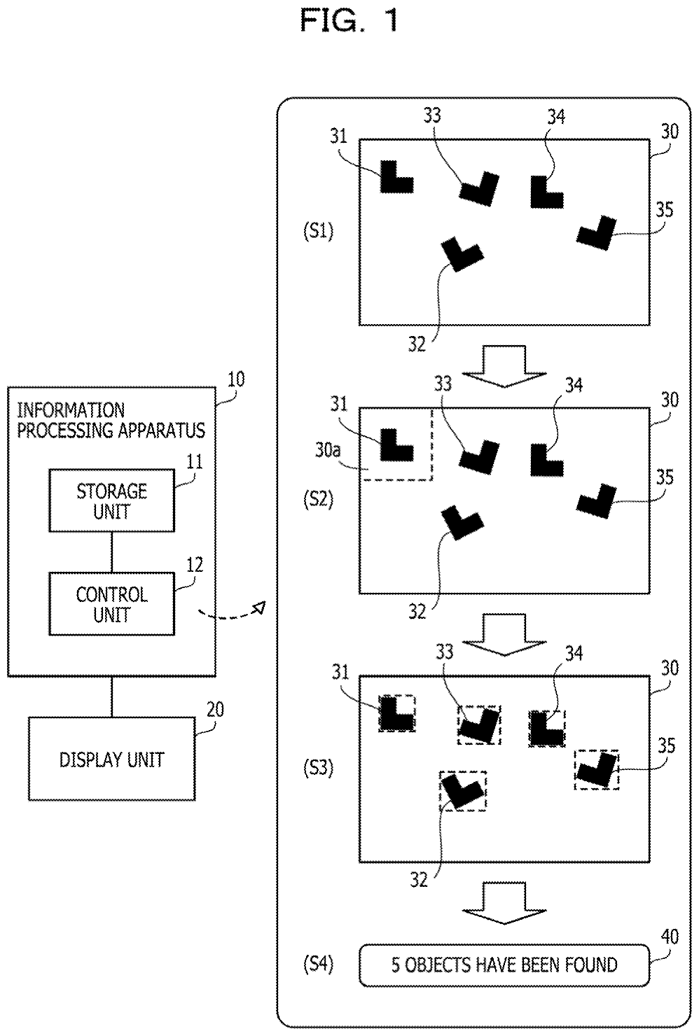

FIG. 1 illustrates an information processing apparatus according to a first embodiment. An information processing apparatus 10 assists counting of a plurality of objects. The information processing apparatus 10 is coupled to a display device 20. The information processing apparatus 10 includes a storage unit 11 and a control unit 12.

The storage unit 11 may be realized by using a volatile storage device such as a random-access memory (RAM) or a nonvolatile storage device such as a hard disk drive (HDD) or a flash memory. The control unit 12 may be realized by using a central processing unit (CPU), a digital signal processor (DSP), an application-specific integrated circuit (ASIC), a field-programmable gate array (FPGA), or the like. The control unit 12 may be realized when a processor executes programs. The “processor” may include a set of a plurality of processors (multiprocessor).

The storage unit 11 stores a captured image including a plurality of objects. For example, the storage unit 11 stores a captured image 30. The captured image 30 is generated by placing a plurality of objects over a display panel and capturing an image from above the display panel by an imaging device in a state in which the plurality of objects are irradiated from below with light by the display panel. Thus, images representing the shape of the objects appear in the captured image 30. The images of the objects in the captured image 30 are simply referred to as objects. For example, the captured image 30 includes objects 31, 32, 33, 34, and 35.

The control unit 12 obtains the captured image 30 and stores the captured image 30 to the storage unit 11. For example, the control unit 12 obtains the captured image 30 from the above-described imaging device (step S1). The captured image 30 may be formed by causing the image obtained from the imaging device to undergone a binarizing process.

The control unit 12 identifies the shape of an object included in a specific region of the captured image 30 (step S2). The specific region is, for example, a quadrangle region 30a having a predetermined size and including the upper left vertex of the captured image 30. The specific region may be another region such as a lower left region, an upper right region, or a lower right region of the captured image 30. Information on the position and the size of the specific region is set in the storage unit 11 in advance. In the example illustrated in FIG. 1, the region 30a includes the object 31. Thus, the control unit 12 identifies the shape of the objects based on the object 31. In order to allow a user to visually recognize a portion corresponding to the region 30a of the captured image 30, a marker indicating the portion may be provided over the display panel in a predetermined color that does not appear in the captured image 30.

For example, the control unit 12 obtains a characteristic indicating the shape of the object 31 based on the object 31 included in the region 30a. For example, the area of the object, the diameter of the minimum circumcircle of the object, or a pattern of the outer edge of the object may be used as the characteristic indicating the shape. For example, the area is calculated by obtaining the number of pixels to which the same label is assigned by a labeling process in which a label is assigned to connected pixels of a predetermined color. For example, a boundary between pixels to which the same label is assigned similarly by the labeling process and other pixels may be extracted as the pattern of the outer edge. The number of vertices of the object or, when the object has a rod shape, the length of the object along the major axis or the like may be used as the characteristic indicating the shape. The control unit 12 may obtain two or more types of the exemplified characteristics. The characteristic obtained for the object 31 in the region 30a is referred to as a reference characteristic.

The control unit 12 counts the number of the plurality of objects included in the captured image 30 based on the identified shape (step S3). For example, the control unit 12 obtains the characteristic indicating the shape of the object for each of the objects 32, 33, 34, and 35 similarly to step S2. The control unit 12 compares the characteristic obtained for each of the objects 32, 33, 34, and 35 with the reference characteristic. When the difference between the compared characteristics is smaller than or equal to a threshold, the control unit 12 determines that the object in question has the same shape as the shape of the object 31 and increases the number of the counted objects with the object in question. In contrast, when the difference between the compared characteristic is greater than the threshold, the control unit 12 determines that the object in question does not have the same shape as the shape of the object 31 and does not increase the number of the counted objects with the object in question.

The control unit 12 may cause the display device 20 to display the captured image 30 and highlight the object having been determined not to have the same shape as the shape of the object 31, thereby prompting the user to change arrangement or the like. For example, when two objects overlap each other and appear in the captured image 30, an object having an area greater than the area of the object 31 may be included in the captured image 30. In this case, the control unit 12 may highlight the objects in question and cause the display device 20 to display a message prompting a change in the arrangement of articles in question. The control unit 12 may accept an input indicating that the arrangement has been changed by the user and execute the processing again from step S1.

FIG. 1 illustrates an example in which each of the objects 32, 33, 34, and 35 is determined to have the same shape as the shape of the object 31, and the number of the determined objects are added to the number of the objects. In this case, the control unit 12 recognizes that the number of the objects appearing in the captured image 30 is 5, and obtains 5 as a counting result.

When two or more types of characteristics are obtained in step S2, the control unit 12 also obtains two or more types of the characteristics for each of the objects 32, 33, 34, and 35. The control unit 12 obtains the differences between the reference characteristics and the obtained characteristics of the same types and, when all the differences obtained for the two or more types of the characteristics are smaller than or equal to thresholds, the control unit 12 determines that the object in question is the same shape as the shape of the object 31. The thresholds used for the comparison may differ depending on the types of the characteristics.

The control unit 12 outputs a counting result of the objects (step S4). For example, the control unit 12 displays, together with the captured image 30, a message 40 such as “5 objects have been found” on the display device 20. The control unit 12 may cause the objects that have been counted to be marked with, for example, rectangles of a predetermined color that surround the counted objects.

For example, it is also conceivable that information on an object is obtained as template data from an image obtained by capturing the object, the template data is registered in advance in a device such as a computer, and this device counts the object appearing in another image by using the template data. However, this method does not necessarily count an item for which the template data has not been registered in advance.

The information processing apparatus 10 identifies the shape of the object included in the specific region 30a of the captured image 30 and counts the plurality of objects included in the captured image 30 based on the identified shape. Thus, the information processing apparatus 10 may count the objects that have not been registered in advance.

Work to register the template data related to an object in advance by using an image other than the captured image 30 may be omitted. This may reduce work to be performed by the user. For example, an image other than the captured image 30 is not necessarily obtained to obtain the template data. Also, time taken to manage and call the template data of the object registered in advance for performing counting may be omitted.

### Second Embodiment

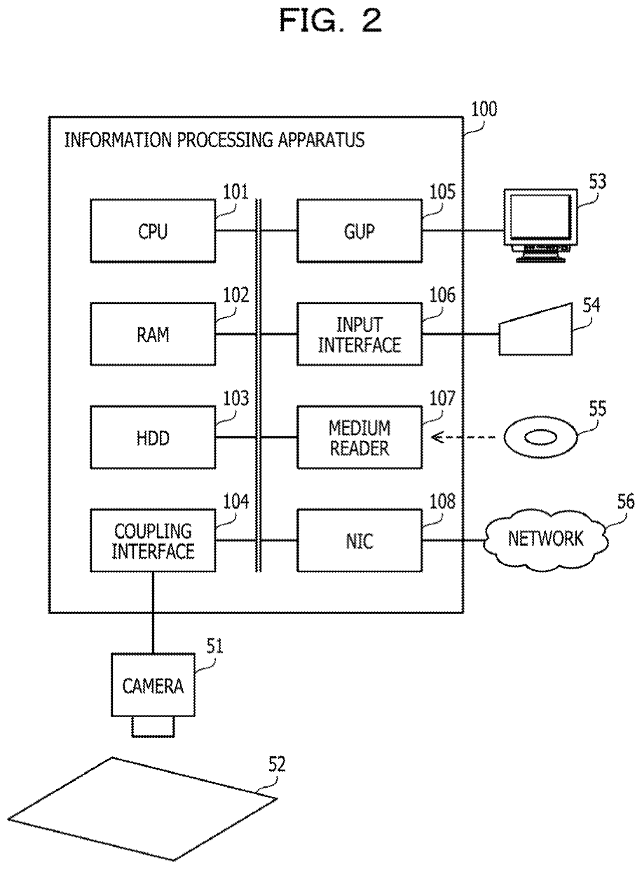

FIG. 2 is a diagram illustrating an example of hardware of an information processing apparatus according to a second embodiment. An information processing apparatus 100 includes a CPU 101, a RAM 102, an HDD 103, a coupling interface 104, a graphics processing unit (GPU) 105, an input interface 106, a medium reader 107, and a network interface card (NIC) 108.

The CPU 101 is an example of the control unit 12 according to the first embodiment. The RAM 102 or the HDD 103 is an example of the storage unit 11 according to the first embodiment. The information processing apparatus 100 may be realized by using a computer.

The CPU 101 is a processor that executes instructions of the programs. The CPU 101 loads at least a subset of the programs or data stored in the HDD 103 into the RAM 102 and executes the programs. The CPU 101 may include a plurality of processor cores. The information processing apparatus 100 may include a plurality of processors. Processing described below may be executed in parallel by using a plurality of processors or processor cores. A set of a plurality of processors may be referred to as a “multiprocessor” or merely referred to as a “processor” in some cases.

The RAM 102 is a volatile semiconductor memory that temporarily stores the programs to be executed by the CPU 101 and data to be used for the operation by the CPU 101. The information processing apparatus 100 may include memories of types other than the RAM and may include a plurality of memories.

The HDD 103 is a non-volatile storage device that stores data as well as the programs of software such as an operating system (OS), middleware, and application software. The information processing apparatus 100 may include other types of storage devices such as a flash memory and a solid-state drive (SSD) and may include a plurality of non-volatile storage devices.

The coupling interface 104 is an interface for coupling to a camera 51. The camera 51 is an imaging device that captures an image of a plurality of objects placed over a light emitting diode (LED) panel 52. According to the second embodiment, a part used for the manufacture of a certain product is described as an example of the object. The LED panel 52 is a rectangular panel over which a plurality of LEDs are arranged in a matrix shape. For example, a plurality of parts placed over the LED panel 52 are illuminated with white light from the opposite side to the camera 51. In a captured image captured by the camera 51 with the light emitted by the LED panel 52, an image representing the shape of the parts placed over the LED panel 52 appears as a shadow, and a region other than the parts in the captured image becomes white. In this manner, the LED panel 52 may emphasize the shape of the parts in the captured image by the irradiation with backlight.

However, when the parts include a transparent portion such as sealing resin of LEDs, it is conceivable that the transparent portion does not appear in the captured image due to the irradiation with the backlight by using the LED panel 52. In this case, a color captured image captured by the camera 51 without the irradiation with the backlight may be used to identify the shape of the parts.

The shape of an entire region of the captured image by the camera 51 is rectangular. The captured image is generated such that the four vertices of the entire region of the captured image match the four vertices of the LED panel 52.

The GPU 105 outputs the image to a display 53 coupled to the information processing apparatus 100 in accordance with an instruction from the CPU 101. As the display 53, any type of the display such as a cathode ray tube (CRT) display, a liquid crystal display (LCD), a plasma display, or an organic electro-luminescence (OEL) display may be used.

The input interface 106 obtains an input signal from an input device 54 coupled to the information processing apparatus 100 and outputs the input signal to the CPU 101. As the input device 54, a pointing device such as a mouse, a touch panel, a touchpad, or a trackball may be used. Also, as the input device 54, a keyboard, a remote controller, a button switch, or the like may be used. A plurality of types of input devices may be coupled to the information processing apparatus 100.

The medium reader 107 is a reading device that reads programs and data recorded in a recording medium 55. As the recording medium 55, for example, a magnetic disk, an optical disk, a magneto-optical (MO) disk, a semiconductor memory, or the like may be used. Examples of the magnetic disk include a flexible disk (FD) and an HDD. Examples of the optical disk include a compact disc (CD) and a Digital Versatile Disc (DVD).

The medium reader 107 copies, for example, the programs and data read from the recording medium 55 to another recording medium such as the RAM 102 or the HDD 103. The read programs are executed by, for example, the CPU 101. The recording medium 55 may be a portable recording medium. The recording medium 55 may be used to distribute the programs and data. The recording medium 55 and the HDD 103 may be referred to as computer-readable recording media.

The NIC 108 is an interface that is coupled to a network 56 and allows communication via the network 56 with another computer. The NIC 108 is coupled to, for example, a communication device such as a switch or a router via a cable.

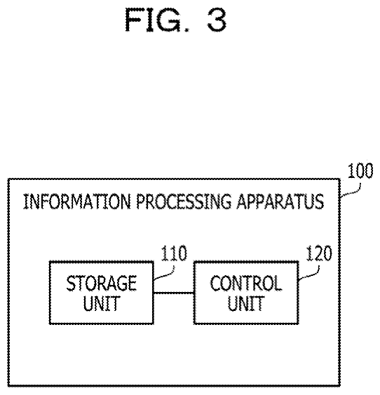

FIG. 3 is a diagram illustrating an example of functions of the information processing apparatus. The information processing apparatus 100 includes a storage unit 110 and a control unit 120. A storage area of the RAM 102 or the HDD 103 is used for the storage unit 110. The control unit 120 is realized when the CPU 101 executes the programs stored in the RAM 102.

The storage unit 110 stores data used for processing performed by the control unit 120. The data stored in the storage unit 110 includes captured images captured by the camera 51. The captured images include images of a plurality of parts that include the parts to be counted.

The control unit 120 obtains a captured image including a plurality of parts and binarizes the captured image. The captured image used in the following processing is a binarized captured image. The binarized captured image is simply referred to as a “captured image”.

The control unit 120 identifies the shape of a part included in the specific region of the captured image. The specific region in the captured image is, for example, held in the storage unit 110 in advance as information indicating a rectangle or a square including the upper left vertex of the captured image. For example, the control unit 120 may use, as the characteristic indicating the shape of the part, the area of the image of the part, the radius of the minimum circumcircle of the image of the part, or the like. The area may be represented by the number of pixels of the image of the part in the captured image. The characteristic of the shape of the part included in the specific region of the captured image is referred to as the reference characteristic.

The control unit 120 counts the number of the plurality of parts included in the captured image based on the identified shape. The control unit 120 obtains the characteristic indicating the shape of the plurality of parts included in the captured image and compares the obtained characteristic with the reference characteristic. The control unit 120 determines that the parts corresponding to the characteristic the difference of which from the reference characteristic is smaller than a threshold are parts having the same shape as the part included in the specific region and adds the determined parts to the counting. The control unit 120 counts the number of the plurality of parts included in the captured image and causes the display 53 to display the counting result.

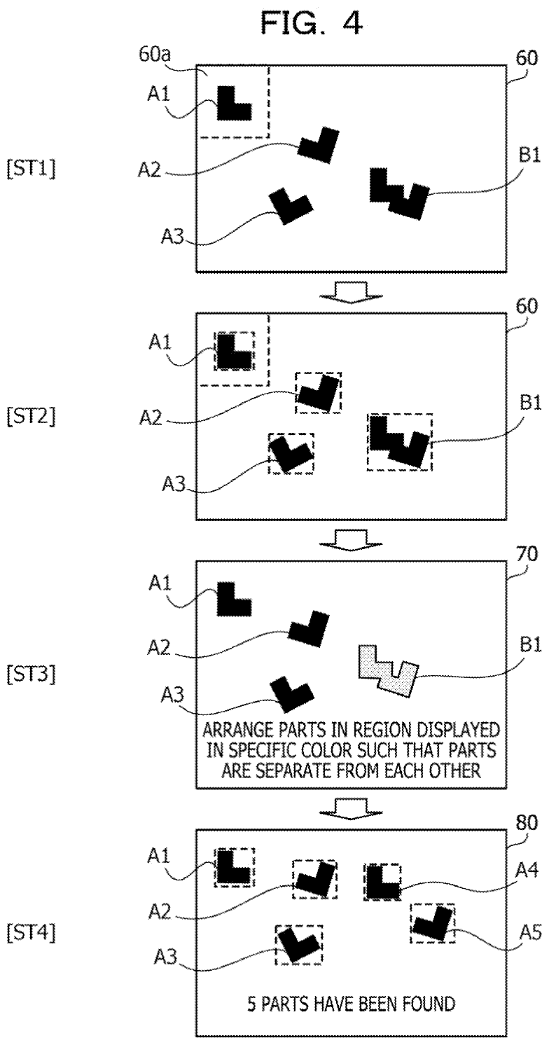

FIG. 4 is a diagram illustrating an example of processing of the information processing apparatus. First, the user places only one of the parts to be counted at a predetermined position such as the upper left of the LED panel 52 in an isolated manner. The user may place the other parts over the LED panel 52 such that the parts are separate from each other. The control unit 120 obtains a captured image 60 obtained by capturing the plurality of parts placed over the LED panel 52 by using the camera 51 (step ST1). In order to allow the user to visually recognize a portion corresponding to a specific region 60a of the captured image 60, a marker indicating the portion may be provided over the LED panel 52 in a predetermined color that does not appear in the captured image 60. The captured image 60 includes part images A1, A2, A3, and B1. The position of the specific region is not limited to the region including the upper left vertex of the captured image 60. The position of the specific region may be another position such as a region including the lower left, upper right, or lower right vertex.

The control unit 120 determines that the part image A1 included in the region 60a of the captured image 60 is an image of a current measurement object part and identifies the shape of the part image A1. The part image A1 becomes a reference part image for identifying the shape of the current measurement object part. Here, a case where the area is used as the characteristic indicating the shape of a part is conceived. In this case, based on the part image A1, the control unit 120 obtains a reference area corresponding to the reference characteristic. For example, the control unit 120 extracts a group of pixels surrounded by white pixels by using the labeling process or the like performed for the captured image 60 and obtains, as the area, the number of pixels belonging to the group. For example, the control unit 120 obtains a reference area Sa1=1200 pixels from the part image A1. Likewise, the control unit 120 obtains an area Sa2 of the part image A2=1200 pixels and an area Sa3 of the part image A3=1200 pixels. Furthermore, the control unit 120 obtains an area Sb1 of the part image B1=2000 pixels (step ST2).

When a color captured image not irradiated with the backlight is used as the captured image as described above, the control unit 120 performs labeling of the part image by using color information of the part in question to obtain information such as the area of the part image in question.

The control unit 120 determines that there is an overlap in a region the area of which is greater than the reference area. In this case, the control unit 120 causes the display 53 to display a message to instruct the user to rearrange the parts (step ST3). For example, the control unit 120 displays, in an emphasized manner on the display 53, an image 70 representing the part image B1 in a specific color with a message “arrange parts in a region displayed in a specific color such that the parts are separate from each other”. It is conceivable that the specific color is a color that is different from the color of the part images A1, A2, and A3 and that easily attracts the attention of the user such as red.

When the user performs the rearrangement, the control unit 120 executes the processing of step ST2 again, counts the number of part images the difference in area of which from the reference area is smaller than or equal to the threshold, and causes the display 53 to display the counting result (step ST4). For example, the control unit 120 newly detects part images A4 and A5 in addition to the part images A1, A2, and A3 from the captured images newly obtained from the camera 51 and obtains an area Sa4 of the part image A4=1200 pixels and an area Sa5 of the part image A5=1200 pixels. The control unit 120 counts the number of part images A1 to A5 the difference in area of which from the reference area of the part image A1 is smaller than or equal to the threshold and obtains “5” as the counting result. Accordingly, the control unit 120 displays on the display 53 an image 80 including a message “5 parts are found”. As the threshold, a value of a predetermined ratio such as 20% relative to the reference area is determined in advance. The threshold may be determined for each type of characteristics to be used.

The control unit 120 may accept a predetermined input from the user to detect that the user has performed the rearrangement or periodically obtain a captured image from the camera 51 to detect the rearrangement in accordance with a change in the captured image.

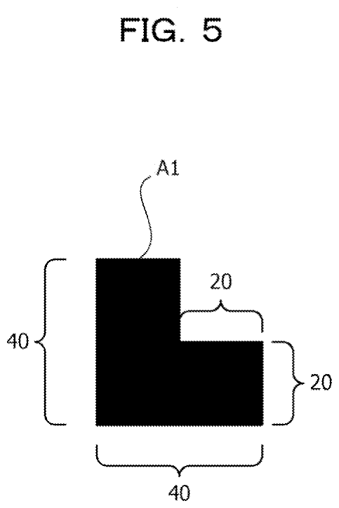

FIG. 5 is a diagram illustrating an example of calculation of the area. As described above, the control unit 120 may calculate the area based on the number of pixels of the part image A1. For example, the area of an L-shaped part image A1 obtained by removing a square having 20 pixels in the vertical direction and 20 pixels in the horizontal direction from a square having 40 pixels in the vertical direction and 40 pixels in the horizontal direction is 40*40−20*20=1200 pixels. Likewise, the area of the other part images may be obtained by the number of pixels.

As the characteristic indicating the shape, a characteristic other than the area may be used. For example, it is conceivable that the diameter or radius of a minimum circumcircle of the part image is used as the characteristic indicating the shape.

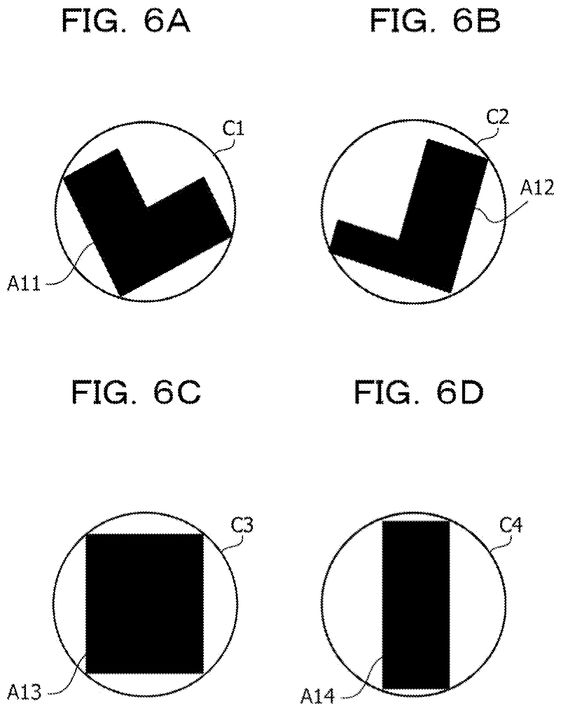

FIGS. 6A to 6D are diagrams illustrating examples of minimum circumcircles. FIG. 6A illustrates an example of a minimum circumcircle C1 of the part image A11. FIG. 6B illustrates an example of a minimum circumcircle C2 of the part image A12. FIG. 6C illustrates an example of a minimum circumcircle C3 of the part image A13. FIG. 6D illustrates an example of a minimum circumcircle C4 of the part image A14. The control unit 120 may use the diameter or the radius of the minimum circumcircle C1 and the like exemplified in FIGS. 6A to 6D as the characteristic indicating the shape.

It is preferable that the characteristic indicating the shape be able to be obtained from each part image by relatively simple operation. The reason for this is that time for counting the parts is reduced by increasing the speed at which the shape of each part included in the captured image is identified. As the other examples of the characteristics indicating the shape, a pattern of the outer edge of the part image, the number of vertices of the part image, the length of the part along the major axis when the part has a rod shape, and so forth are conceivable. The control unit 120 may use two or more types of the characteristics.

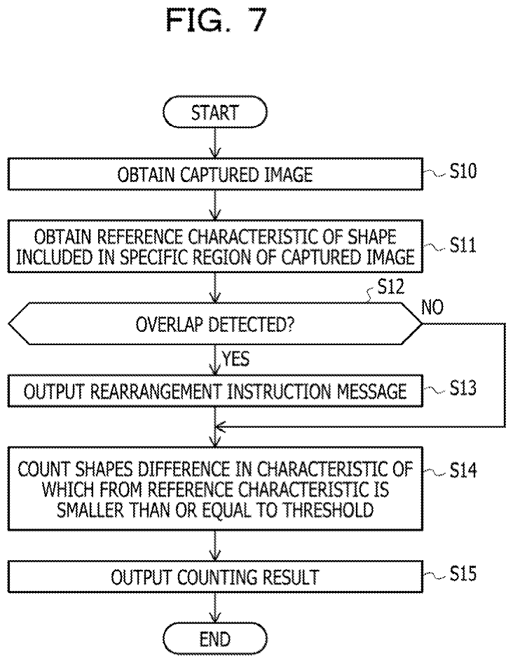

FIG. 7 is a flowchart illustrating an example of the processing of the information processing apparatus. (S10) The control unit 120 obtains a captured image by the camera 51. The control unit 120 binarizes the captured image.

(S11) The control unit 120 obtains the reference characteristic corresponding to the shape of the reference part image included in the specific region of the captured image. As the type of the characteristic, for example, the area of the part image, the minimum circumcircle of the part image, or the like is conceivable.

(S12) The control unit 120 determines whether an overlap of parts is detected. When the overlap of the parts is detected, the control unit 120 proceeds the processing to step S13. When the overlap of the parts is not detected, the control unit 120 proceeds the processing to step S14. For example, the control unit 120 detects a part image having the characteristic of the shape greater than the reference characteristic as a region including the overlap of the parts. In the case where two or more types of the characteristics are used, the control unit 120 may detect a part image at least one characteristic of which is greater than the reference characteristic as the region including the overlap of the part.

(S13) The control unit 120 outputs a rearrangement instruction message for the region where the overlap of the parts is detected. For example, the control unit 120 displays the rearrangement instruction message on the display 53 to prompt the user to correct the overlap of the parts.

(S14) The control unit 120 counts, in the captured image, shapes the difference in characteristic of which from the reference characteristic is smaller than or equal to the threshold. In the case where two or more types of the characteristics are used, the control unit 120 obtains two or more types of the characteristics for each part image included in the captured image. The control unit 120 obtains the differences between the reference characteristics and the obtained characteristics of the same types and, when all the differences obtained for the two or more types of the characteristics are smaller than or equal to the thresholds, the control unit 120 determines that the part image in question is the same shape as the shape of the reference part image and adds the determined part image to the counting. In the case where the difference obtained for at least one characteristic is greater than the threshold, the control unit 120 determines that the part image in question has a shape different from that of the reference part image and does not add the part image in question to the counting.

(S15) The control unit 120 outputs the counting result. For example, the control unit 120 causes the display 53 to display the counting result to notify the user of the number of the parts in question. Then, the processing of the information processing apparatus 100 ends.

In the output of the counting result in step S15, the control unit 120 may display the part images that have been counted and the part images that have not been counted on the display 53 in a distinguishable manner.

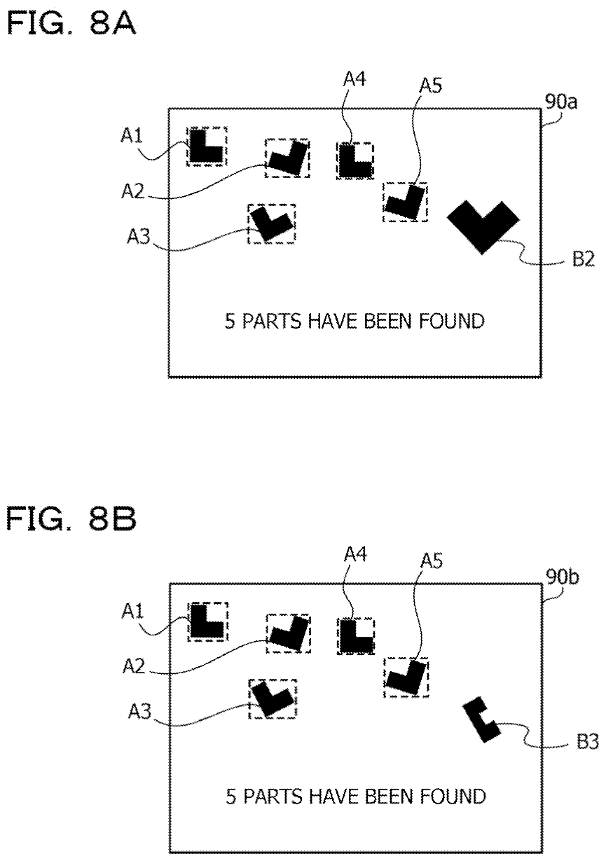

FIGS. 8A and 8B are diagrams illustrating examples of the display of the counting result of the information processing apparatus. FIG. 8A illustrates an example of an image 90a that notifies of the counting result obtained when the part images A1, A2, A3, A4, and A5 are counted and a part image B2 is not counted with reference to the reference part image A1. The control unit 120 causes the display 53 to display the image 90a to notify the user of the counting result. For example, the control unit 120 may display the part image A1 to A5 that have been counted and the part image B2 in a distinguishable manner by surrounding with a frame each of the part images A1 to A5 that have been counted and not surrounding the part image B2 that has not been counted.

The control unit 120 may highlight the part image B2 in a specific color such as red in the image 90a and further display a message on the display 53 to prompt the user to review the arrangement.

FIG. 8B illustrates an example of an image 90b that notifies of the counting result obtained when the part images A1, A2, A3, A4, and A5 are counted and a part image B3 is not counted with reference to the reference part image A1. The control unit 120 causes the display 53 to display the image 90b to notify the user of the counting result.

The control unit 120 may improve accuracy in identifying the part image having the same shape as the shape of the reference part image A1 by combining two or more types of characteristics such as the diameter of the minimum circumcircle and the area of the part image. Similarly to FIG. 8A, the control unit 120 may highlight the part image B3 in a specific color such as red in the image 90b and further display a message on the display 53 to prompt the user to review the arrangement.

For example, it is also conceivable that information on an object is obtained as template data from an image obtained by capturing the object, the template data is registered in advance in a device such as a computer, and this device counts the object appearing in another image by using the template data. However, this method does not necessarily count an item for which the template data has not been registered in advance. In addition, there are a lot of misoperation and efforts in the registration process performed by the user.

The information processing apparatus 100 identifies the shape of the object included in the specific region of the captured image and counts the plurality of objects included in the captured image based on the identified shape. Thus, the information processing apparatus 100 may count the objects that have not been registered in advance.

Work to register the template data related to an object in advance by using an image other than the captured image may be omitted. This may reduce work to be performed by the user. For example, an image other than the captured image is not necessarily be obtained to obtain the template data. Also, time taken to manage and call the template data of the object registered in advance for performing counting may be omitted.

For example, the information processing apparatus 100 performs the following processing.

The control unit 120 obtains a captured image of a plurality of objects, identifies the shape of an object included in a specific region of the captured image, and, based on the identified shape, counts the number of the plurality of objects included in the captured image.

Thus, objects that have not been registered in advance may be counted. Since the registration of an object in advance is not necessarily performed, the objects may be counted by a single capturing operation with an imaging device such as the camera 51.

The captured image may include another item different from the plurality of objects. The control unit 120 distinguishes between the objects to be counted and the other item included in the captured image based on the identified shape.

Thus, mixing of a wrong item may be detected, and accordingly, only the objects that have been identified with reference to a reference shape and that is to be counted may be appropriately counted.

For example, the control unit 120 identifies a first characteristic (reference characteristic) corresponding to the shape of the object included in the specific region of the captured image. The control unit 120 distinguishes between the objects to be counted and the other item in accordance with a comparison between a second characteristic that corresponds to the shape of the plurality of objects included in the captured image and the first characteristic and a comparison between a second characteristic that corresponds to the shape of the other item included in the captured image and the first characteristic.

Thus, mixing of a wrong item may be detected, and accordingly, only the objects that have been identified with reference to a reference shape and that is to be counted may be appropriately counted.

The control unit 120 may use, for example, at least one of a value indicating the area and a value indicating the diameter of the minimum circumcircle as the first characteristic and the second characteristics.

As information on the shape, the area and the diameter of the minimum circumcircle are information that may be obtained with a relatively small amount of operation. Accordingly, distinction between the objects to be counted and the item not to be counted may be performed at high speed. Although the diameter is described as the example, instead of the diameter, the radius of the minimum circumcircle may be used substantially in the same manner.

As the shape information, a plurality of types of information such as the area and the diameter of the minimum circumcircle may be used. This may increase accuracy of distinction between the objects to be counted and the item not to be counted.

The control unit 120 may output an image that represents the objects to be counted and other item and that includes at least one of a message indicating the number of the objects to be counted and a message that notifies of a change in the arrangement of the other item.

Thus, with the information processing apparatus 100, the user may check the counting result of the objects and the item not to be counted, and the information processing apparatus 100 may assist an increase in efficiency of work to be performed by the user. The information processing apparatus 100 may also reduce the user's work. For example, in some cases, objects placed over an LED panel may overlap each other or an item not to be counted may be mixed. Even in such cases, the information processing apparatus 100 may appropriately prompt the user to check.

Information processing according to the first embodiment is realized by causing the control unit 12 to execute the programs. Information processing according to the second embodiment is realized by causing the CPU 101 to execute the programs. The programs may be recorded in the computer-readable recording medium 55.

For example, the programs may be distributed by distributing the recording medium 55 in which the programs are recorded. The programs may be stored in another computer and distributed via a network. For example, the computer may store (install), in a storage device such as the RAM 102 or the HDD 103, the programs recorded in the recording medium 55 or programs received from another computer, and may read the programs from the storage device to execute the programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a counting program for causing a computer to execute a process, the process comprising:
obtaining a captured image that includes a plurality of objects;
identifying a shape of an object included in a specific region of the captured image; and
counting a number of the plurality of objects included in the captured image based on the identified shape.

2. The non-transitory computer-readable recording medium according to claim 1, wherein
the captured image includes another item different from the plurality of objects, and wherein
the counting of the number includes distinguishing between the plurality of objects and the other item included in the captured image based on the identified shape.

3. The non-transitory computer-readable recording medium according to claim 2, wherein
the identifying of the shape includes identifying of a first characteristic that corresponds to the shape of the object included in the specific region, and wherein
the distinguishing is executed in accordance with a comparison between a second characteristic that corresponds to the shape of the plurality of objects included in the captured image and the first characteristic and a comparison between a second characteristic that corresponds to the shape of the other item included in the captured image and the first characteristic.

4. The non-transitory computer-readable recording medium according to claim 3, wherein
the first characteristic, the second characteristic that corresponds to the shape of the plurality of objects, and the second characteristic that corresponds to the shape of the other item each include at least one of a value that indicates a corresponding area or a value that indicates a diameter of a corresponding minimum circumcircle.

5. The non-transitory computer-readable recording medium according to claim 2, further comprising:
outputting an image that represents the objects and the other item and that includes at least one of a message which indicates the number of the plurality of objects that have been counted or a message which notifies of a change in the arrangement of the other item.

6. A counting method comprising:
obtaining, by a computer, a captured image that includes a plurality of objects;
identifying a shape of an object included in a specific region of the captured image; and
counting a number of the plurality of objects included in the captured image based on the identified shape.

7. An information processing apparatus comprising:
a memory; and
a processor coupled to the memory and configured to:
obtain a captured image that includes a plurality of objects;
identify a shape of an object included in a specific region of the captured image; and
count a number of the plurality of objects included in the captured image based on the identified shape.
